(19) United States
(12) Patent Application Publication
(10) Pub. No.: US 2026/0359311 A1
(43) Pub. Date: Nov. 12, 2026

(54) EFFICIENT SEARCH SYSTEM

(71) Applicant: MASTERCARD INTERNATIONAL INCORPORATED,, Purchase, NY (US)

(72) Inventors: Natesh Babu ARUNACHALAM, Herriman, UT (US); Chandra TUPELLY, Bangalore (IN)

(73) Assignee: MASTERCARD INTERNATIONAL INCORPORATED,, Purchase, NY (US)

(21) Appl. No.: 19/201,663

(22) Filed: May 7, 2025

(51) Int. Cl. G06F 16/2458; G06F 16/22

(52) U.S. Cl. CPC G06F 16/2462; G06F 16/2246

(57) ABSTRACT

A system may access a plurality of data records, each data record having a reference string. The system may generate a plurality of reference vectors in a vector space based on the plurality of data records, each reference vector comprising a numeric representation of a corresponding reference string from among the plurality of data records. The system may generate an index based on the plurality of reference vectors and access an input query having a query string to be searched against the plurality of data records. The system may generate a query vector comprising a numeric representation of the query string. The system may identify a subset of reference vectors, from among the plurality of reference vectors, based on a proximity each of the subset of reference vectors to the query vector in the vector space. The system may generate a query result based on the subset of reference vectors.

### BACKGROUND

Search and retrieval systems often rely on exact matches between a query input and a set of reference records stored in a database. For example, if a query input includes a string of characters, such as “ABC company,” a database system may perform an exact or fuzzy match search for reference records containing the same or similar string. Some retrieval systems may use wildcards to facilitate partial matches. In either instance, searching reference records in this way can be computationally expensive and inefficient, especially when millions of records or more are to be searched.

### BRIEF DESCRIPTION OF THE DRAWINGS

Features of the present disclosure may be illustrated by way of example and not limited in the following figure(s), in which like numerals indicate like elements, in which:

FIG. 1 illustrates an example of a system environment for an efficient search system;

FIG. 2 illustrates an example of a data flow for efficient search based on an approximate nearest neighbor model;

FIG. 3 illustrates an example of an implementation of an efficient approximate nearest neighbors search for searching open banking and other transaction data records;

FIG. 4 illustrates an example of an implementation of an efficient approximate nearest neighbors search based on a self search of a reference corpus that has been vectorized;

FIG. 5 illustrates an example of an implementation of an efficient approximate nearest neighbors search of an unlabeled data record against labeled data records that have been vectorized to identify unique unlabeled data for labeling and training ML models;

FIG. 6 illustrates an example of a method of generating and efficiently searching an indexed vector data structure; and

FIG. 7 illustrates an example of a computer system that may be implemented by devices illustrated in FIG. 1.

### DETAILED DESCRIPTION

The disclosure relates to methods and systems of efficiently searching reference records that include strings of characters. For example, the system may generate an indexed data structure in which reference records are mapped into a high-dimensional vector space in which similar reference records are clustered together. The system may map a query input (or other search content) into the vector space using similar mapping techniques and identify nearby neighbors according to a similarity metric, such as a metric that can measure the distance between points in the vector space.

The system may organize reference vectors into an indexed data structure for efficient searching. The system may generate different types of indexed data structures based on one or more different indexing techniques. In tree-based indexing and searching, the system may recursively partition reference vectors into a tree-like structure. In these examples, searching may include traversing the tree based on a query vector. In hashing-based indexing, a hashing function may assign similar vectors to the same hash bin. Multiple hash tables with different similarity measures can be used. In these examples, searching may involve hashing a query vector using the hashing function, and looking up corresponding reference vectors in the hash table.

In graph-based indexing and searching, reference vectors are represented as nodes in a graph, with edges connecting similar vectors. In these examples, searching may include traversing the graph, starting from select nodes and moving towards neighbors that are closest to the query vector. Greedy search is mentioned as a possible traversal method. In some examples, the system may filter the results from the search. For example, after identifying approximate nearest neighbors, the system may further filter based on distance filtering (e.g., edit distance using n-grams) and string similarity filtering (e.g., cosine similarity using n-grams).

The system may be used in various contexts in which content is to be searched against a set of reference records. For example, the system may improve feature labeling performance for machine learning models. Supervised and semi-supervised machine learning algorithms typically require large quantities of high-quality labeled data to train models. While the resulting models can provide powerful predictive capabilities, they can overfit the labeled training data when that data insufficiently represents real-world data. This can lead to a machine learning model that is trained to fit only the observed labeled data and may not generalize well to real-world input data, resulting in poor performance. To address this, the system may automatically assess candidate data to efficiently determine whether it is duplicative of existing labeled data. The system may identify candidate data that is unique and will add to the diversity of the labeled training data. The system is especially helpful when the corpus of labeled data is large and therefore difficult and computationally intensive to search, particularly when the labeled data includes strings.

In other contexts, the system may improve search and retrieval systems in which a query input is searched against reference records. For example, in a transaction context, the system may efficiently search and retrieve transactions that are similar to an input transaction. This can be implemented as a search function for a user wishing to find transactions and/or for a system to determine whether an input transaction is fraudulent by searching against a set of known fraudulent transactions. In this context, an input transaction that is found to be similar to the set of known fraudulent transactions can be flagged as fraudulent for mitigative action (such as canceling or denying a transaction request). In some examples, the content can be from the set of reference records themselves to identify similar records within the reference records. These and other search function may be scalable to handle large volumes of transaction data, making it an ideal solution for big data applications such as in the open banking domain.

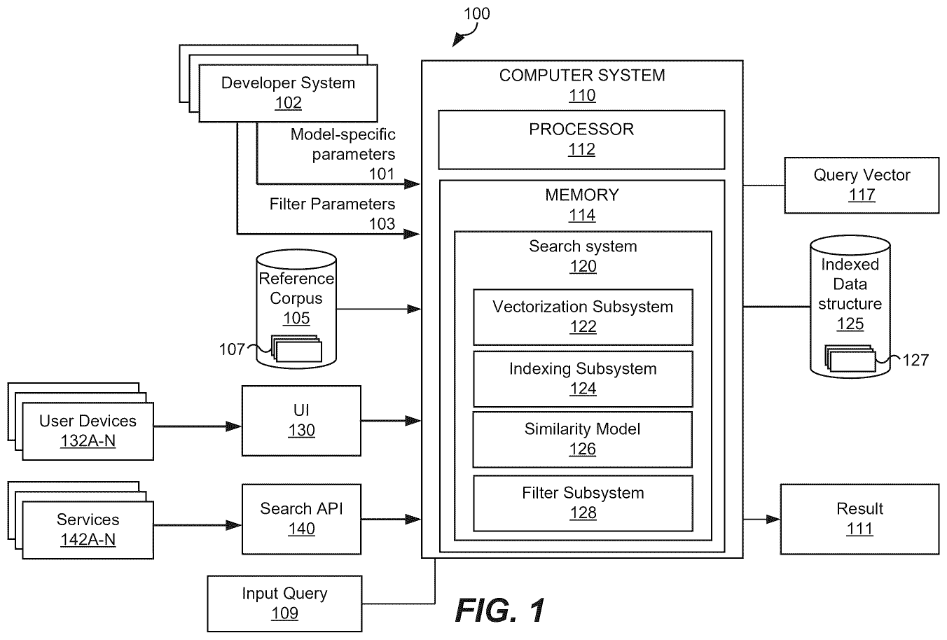

FIG. 1 illustrates an example of a system environment 100 of automatically generating rules based on an evolutionary algorithm, which may address these and other issues with conventional ways to generate rules. The system environment 100 may include a developer system 102, a reference corpus 105, a computer system 110, an indexed data structure 125, a user interface (UI) 130, one or more user devices 132A-N, a search API 140, one or more services 142A-N, and/or other components. At least some of the components of the system environment 100 may be connected to one another via a communication network, which may include the Internet, an intranet, a Personal Area Network, a LAN (Local Area Network), a WAN (Wide Area Network), a SAN (Storage Area Network), a MAN (Metropolitan Area Network), a wireless network, a cellular communications network, a Public Switched Telephone Network, and/or other network through which system environment 100 components may communicate.

A developer system 102 is a computer or application that provides model-specific parameters 101 and filter parameters 103 for executing a similarity model 126. A user such as a developer may operate the developer system 102 to set the values for the model-specific parameters 101 and filter parameters 103. Some or all of values for the model-specific parameters 101 and filter parameters 103 may be set by a user device 132 and/or a service 142 instead of, or in addition to, the developer system 102.

A model-specific parameter 101 is a configurable parameter that specifies various operations of the similarity model 126. For example, a model-specific parameter 101 may include a k-value, a distance metric parameter, a weighting parameter, a model type parameter, and/or other parameters that may be used to configure model operations. The k-value may specify the number of nearest neighbors to select. The k-value may be predefined and set to an arbitrary value.

In some examples, the k-value may be defined by a developer, other user, or the system. The distance metric parameter specifies one or more distance metrics to use. Distance metrics may include a Euclidean distance, a Cosine similarity, and/or other function to determine a distance between two points, such as in the vector space. The weighting parameter specifies an amount of influence that a given neighbor will have on another neighbor in the vector space. For example, closer neighbors may be weighted more so than further neighbors. The model type parameter may specify the type of indexing and searching to use, as described herein.

A filter parameter 103 is a configurable parameter that specifies how filtering is performed by the filter subsystem 128. For example, a filter parameter 103 may include an N-value that defines a number of top nearest k-neighbors to select, a threshold similarity value, an edit distance threshold, a number of N-grams to use for string similarity, and/or other parameters that can be used to filter results of the similarity model 126 based on string similarity.

The threshold similarity value is parameter that specifies the minimum level of similarity required for two strings to be considered a match. For example, a threshold of 0.8 might mean that two strings must be at least 80% similar to be considered a match. E.g., cosine similarity The edit distance threshold may is a parameter that specifies the maximum number of edits (insertions, deletions, or substitutions) that can be made to one string to make it identical to the other string. For example, an edit distance of 2 might mean that two strings can be considered a match if they are at most two edits apart The number of N-grams to use for string similarity is a parameter specifies the length of the character sequences (n-grams) that are used to compare the two strings. For example, a value of 3 might mean that the algorithm compares the strings based on their 3-character sequences.

In some examples, the filter subsystem 128 may include other types of filters other than string similarity. For example, the filter subsystem 128 may implement date filters, merchant filters, category filters, and/or other types of filters. In this way, approximate nearest neighbor search may be conducted, then filter by other types of filter parameters to further filter entries in the query result 111.

The reference corpus 105 is a database that or source of a plurality of data records 107. Each data record 107 may include a string (also referred to as a “reference string of characters”). The string may include characters such as letters and numbers. The content of the string will vary depending on the implementation of the computer system 110. For example, in the context of payment transactions, the string may be the name of a payee.

A user device 132 is a computer device that a user uses to interface with a User Interface (UI) 130. In some examples, the UI 130 may submit queries via a Search Application Programming Interface (API) 140. A service 142 is a computer or application that requests a query to be conducted based on input data. In some examples, the query is provided via the Search API 140. Examples of services may include fraud detection services, subscription or recurring payment discovery services, feature labeling for machine learning systems, and/or other computer processes. In fraud detection, an input query corresponds to a transaction for which fraud detection is to be made by finding similar transactions using the efficient search described herein.

The computer system 110 may include one or more computing devices that conducts efficient search based on vectors and nearest neighbors in a vector space. The one or more computing devices of the computer system 110 may each include a processor 112, a memory 114, a search system 120, and/or other components.

The processor 112 may be a semiconductor-based microprocessor, a central processing unit (CPU), an application specific integrated circuit (ASIC), a field-programmable gate array (FPGA), and/or other suitable hardware device. Although the computer system 110 has been depicted as including a single processor 112, it should be understood that the computer system 110 may include multiple processors, multiple cores, or the like. The memory 114 may be an electronic, magnetic, optical, or other physical storage device that includes or stores executable instructions. The memory 114 may be, for example, Random Access memory (RAM), an Electrically Erasable Programmable Read-Only Memory (EEPROM), a storage device, an optical disc, and the like. The memory 114 may be a non-transitory machine-readable storage medium, where the term “non-transitory” does not encompass transitory propagating signals.

The search system 120 may include a vectorization subsystem 122, an indexing subsystem 124, a similarity model 126, a filter subsystem 128, and/or other features. One or more of the search system 120, the vectorization subsystem 122, the indexing subsystem 124, the similarity model 126, and the filter subsystem 128 may each be implemented as instructions that program the processor 112. Alternatively, or additionally, one or more of the search system 120, the vectorization subsystem 122, the indexing subsystem 124, the similarity model 126, and the filter subsystem 128 may be implemented in hardware.

The vectorization subsystem 122 may generate a vector based on a string. For example, the vectorization subsystem 122 may convert a string into a vector, which is a numerical representation of a string. Each vector may exist within a vector space, which is defined based on how the vectorization subsystem 122 performs vectorization. The dimensionality of the vector space will therefore vary based on the type of vectorization performed by the vectorization subsystem 122. The position of vectors in the vector space may be indicative of their similarity. For example, vectors that are closer to one another in the vector space are more similar to one another than vectors that are further from one another in the vector space. The similarity between a two or more vectors may therefore be determined based on their respective positions in the vector space.

In some examples, the vectorization subsystem 122 may generate vectors from strings based on the Term Frequency-Inverse Document Frequency (TF-IDF). TF-IDF measures the importance of words in a string relative to a larger dataset. In these examples, the vectorization subsystem 122 may determine the relative importance of words in the query string against the words in the reference corpus 105. Also in these examples, the vector space may be a mathematical representation in which each string of the data record 107 in the reference corpus 105 and the string of the query input is represented as a vector. Each unique word in the reference corpus 105 and the string of the query input may be represented as a dimension in this vector space. Records that share more words will result in their corresponding vectors being closer to one another in the vector space than records that share less words. In some examples, certain noisy words may be removed from consideration. Noisy words may be those that are common or otherwise do not provide uniqueness or context to the string or record. For example, noisy words may “a,” “the,” “of” and/or similar words that are commonly found across different records.

In some examples, the vectorization subsystem 122 may generate vectors from strings based on word embeddings. Word embeddings represent words in strings as dense vectors, capturing semantic meaning and relationships between words. The word vectors may be arranged in a high-dimensional space in which the distance and direction between vectors reflect semantic similarity. Word embeddings may be more useful for when data records 107 include natural language text strings to capture their semantic context. To generate word embeddings, the vectorization subsystem 122 may use WORD2VEC, GLOVE, and/or other techniques to generate word embeddings.

In some examples, the vectorization subsystem 122 may generate vectors from strings based on sentence embeddings. Like word embeddings, sentence embeddings may be more useful for when data records 107 include natural language text strings to capture their semantic context. To generate word embeddings, the vectorization subsystem 122 may use BERT, Sentence-BERT, Universal Sentence Encoder, and/or other sentence embedding algorithms.

For examples in which an input query 109 is used to search the data records 107, the search system 120 may use the vectorization subsystem 122 to generate a query vector 117 based on the input query 109. In some examples, to enhance efficient searching, the indexing subsystem 124 may generate reference vectors 127 based on the data records 107. For example, the indexing subsystem 124 may use the vectorization subsystem 122 to generate a reference vector 127 for each data record 107.

In some examples, the indexing subsystem 124 may generate an indexed data structure 125. To do so, the indexing subsystem 124 may vectorize a data record 107 to generate a corresponding reference vector 127. For example, the indexing subsystem 124 may use the vectorization subsystem 122 to vectorize the data record 107. The indexing subsystem 124 may assign an index identifier for each data record 107 and store the index identifier in association with the data record 107. In some examples, the indexing subsystem 124 may store the index identifier in association with the reference vectors 127. One, or both, of these stored associations may be used to retrieve the original data record 107 for a corresponding reference vector 127. In this way, when a reference vector 127 is identified as an approximate nearest neighbor, then the corresponding data record 107 from which the reference vector 127 was generated may be retrieved and included in the query result 111. The indexing subsystem 124 may repeat this vectorization for each data record 107. Once the data records 107 have been vectorized and mapped to their corresponding data record 107, the indexing subsystem 124 may generate the indexed data structure 125 based on the reference vectors 127. In some examples, the indexing subsystem 124 may periodically build the indexed data structure 125 to account for any new data records 107. For example, the indexing subsystem 124 may build the indexed data structure 125 on a daily, weekly, monthly or other periodic basis. In some examples, the indexing subsystem 124 may build the indexed data structure 125 when a threshold number of new data records 107 becomes available.

The indexing subsystem 124 may organize the reference vectors 127 to generate the indexed data structure 125, creating an index for efficient searching. For example, the indexing subsystem 124 may generate the indexed data structure 125 based on tree-based indexing, hashing-based indexing, graph-based indexing, hybrid approaches that use combinations of these techniques, or other techniques that can build data structures from the reference vectors 127 that can be efficiently searched. The similarity model 126 may search the indexed data structure 125 to conduct an efficient search of the reference vectors 127. The nature of the search may vary depending on the indexing techniques, as will be described below. In the examples that follow, searching will be described in the context of an input query 109 that is vectorized into a query vector 117 and then searched against the indexed data structure 125. It should be noted, however, that the input for searching may be one or more of the reference vectors 127 to conduct a self search.

### Tree-Based Indexing and Search

In tree-based indexing, the indexing subsystem 124 may recursively partition the reference vectors 127. In a K-dimensional tree, for example, the indexing subsystem 124 may partition the reference vectors 127 on one or more dimensions. In some examples, the indexing subsystem 124 may partition the reference vectors 127 based on a partitioning value. The partitioning value may be the median value of the one or more dimensions across the reference vectors 127, like distance from a center point or enclosing radii, and/or other value. In some examples, the indexing subsystem 124 may partition some or all of the reference vectors 127 based on a randomly selected partitioning point.

The indexing subsystem 124 may recursively perform the foregoing partitioning until the reference vectors 127 have been partitioned, forming a tree-like structure in which branches are defined by portioning points. In particular, the indexed data structure 125 may result in a tree structure in which each internal node represents a decision (a split based on a hyperplane) and each leaf node contains a subset of the reference vectors 127. In some examples, the indexing subsystem 124 may generate multiple trees based on different portioning values (such as portioning values) or partitioning techniques (such as based on median values or randomly selected partitioning points).

Searching the indexed data structure 125 having a tree-like structure may be based on an efficient tree traversal. For example, tree-based indexing partitions the vector space, allowing efficient pruning of the search space during a query. Search speed is improved compared to traditional exact match searching. Examples of the tree structure include K-dimensional trees, ball trees, vantage-point trees, and cover trees.

In particular, based on the tree-based indexing, the similarity model 126 may search the indexed data structure 125 by traversing the tree structure. For example, the similarity model 126 may traverse down the tree node by deciding, at each tree node, whether to traverse down a branch based on one or more splitting criteria. Traversal down the tree structure will head towards a region of the tree having reference vectors 127 that are more likely to contain vectors that are similar to the query vector 117 (or other search input). Reference vectors 127 in a leaf node are candidate matches. If multiple trees were indexed (based on different tree formation, for example), In an approximate search, the similarity model 126 may query the different trees to identify candidate matches.

### Hashing-Based Indexing and Search

In hashing-based indexing, the indexing subsystem 124 may execute a hashing function on the reference vectors 127. The hashing function may include, for example, a Locality-Sensitive Hashing function. For each reference vectors 127, the hashing function may assign the reference vectors 127 to a hash bin. A hash bin is a hashing result that is shared among similar inputs. For example, the hashing function may hash a first set of reference vectors 127 that are similar to one another into a first hash bin and a set of reference vectors 127 that are similar to one another into a second hash bin. Thus, multiple reference vectors 127 may hash to a single hash bucket, which may be identified by a hash identifier. The indexing subsystem 124 may generate a hash table keyed by a hash identifier, which is associated with the corresponding reference vectors 127 in that hash bin. The hash table may therefore include multiple hash identifiers that are each associated with a respective set of reference vectors 127 that are similar to one another within their hash bin.

Different hashing functions may use different similarity measures to assess similarity for hash binning. In some examples, the indexing subsystem 124 may generate multiple hash tables, each hash table corresponding to a respective similarity measure. Thus, to improve reliability while maintaining speed, the indexing subsystem 124 may use multiple similarity measure to generate multiple hash tables, which may be consulted when performing an efficient search. In this way, even if one hash table misses a similarity comparison, another hash table may not miss the similarity comparison. Examples of similarity metrics may include Jaccard similarity, Cosine similarity, and Euclidean distance. In these examples, the indexing subsystem 124 may generate a respective hash table from the reference vectors 127 for some or all of these similarity metrics.

Based on the hashing-based indexing, the similarity model 126 may search the indexed data structure 125 by generating a hash of the query vector 117 using the one or more hashing functions used by the indexing subsystem 124. The hashing will identify one or more hash bins to which the query vector 117 belongs. The similarity model 126 may then consult the one or more hashing tables using the one or more hash bins as keys to lookup the corresponding reference vectors 127.

### Graph-Based Indexing and Search

In graph-based indexing, the indexing subsystem 124 may represent each reference vector 127 as a node in a graph. Edges in the graph connects reference vectors 127 to one another. An edge may therefore define a neighbor relationship between connected nodes (reference vectors 127). To construct the graph, the indexing subsystem 124 may use one or more similarity metrics (such as those described for hashing-based indexing) to determine similarity of the reference vectors 127 with respect to one another and connect similar nodes via an edge.

The search system 120 may use the similarity model 126 to search the indexed data structure 125 based on a query vector 117. The similarity model 126 may search the indexed data structure 125 depending on the particular indexing technique used by the indexing subsystem 124 and to identify approximate nearest neighbors of the query vector 117.

Based on the graph-based indexing, the similarity model 126 may search the indexed data structure 125 by traversing the graph. For example, the similarity model 126 may select one or more nodes in the graph and start traversal at the selected one or more nodes. The similarity model 126 may randomly select these starting nodes or may specifically select nodes that are well-connected, such as having a threshold number of edges to other nodes. The threshold number of edges to other nodes may be predefined and configured as needed.

In some examples, the similarity model 126 may perform a greedy search from the one or more starting nodes. To conduct the greedy search, at each step of traversal, the similarity model 126 moves to the neighbor node that is closest to the query based on a similarity or distance metric described herein. The similarity model 126 may continue the search until no neighbor is found that is closer to the query vector 117 than the current node. Due to the graph's structure, this process tends to converge to a set of candidate nodes that are similar to the query vector 117. In some examples, to avoid local minima, the similarity model 126 may explore multiple paths or backtrack slightly (one or more edges) if a local minima is found.

Using one or more of the foregoing indexing and searching, the search system 120 may identify candidate matches for results 111 without performing exact string matches, which can be computationally intensive.

In some examples, once the nearest neighbors (such as approximate nearest neighbors) are identified, the search system 120 may further filter the results. For example, the filter subsystem 128 may filter the top N approximate nearest neighbors from the similarity model 126 using distance filtering, string similarity filtering, and/or other filtering. In distance-based filtering, n-grams can be used to calculate the distance between two strings. For example, the edit distance between two strings can be calculated by counting the number of edits (insertions, deletions, or substitutions) that are needed to transform one string into another string. This can be done by comparing the n-grams of the two strings. In string similarity filtering, n-grams can be used to calculate the similarity between two strings. For example, the cosine similarity between two strings can be calculated by counting the number of shared n-grams between the two strings.

The search system 120 may generate a query result 111 based on the similarity matching in the vector space by the similarity model 126 and/or the filtering by the filter subsystem 128. For example, the search system 120 may obtain the reference data record 107 corresponding to the reference vector 127 that is similar to the query vector 117 in the vector space and return the data record 107 as at least part of the query result 111.

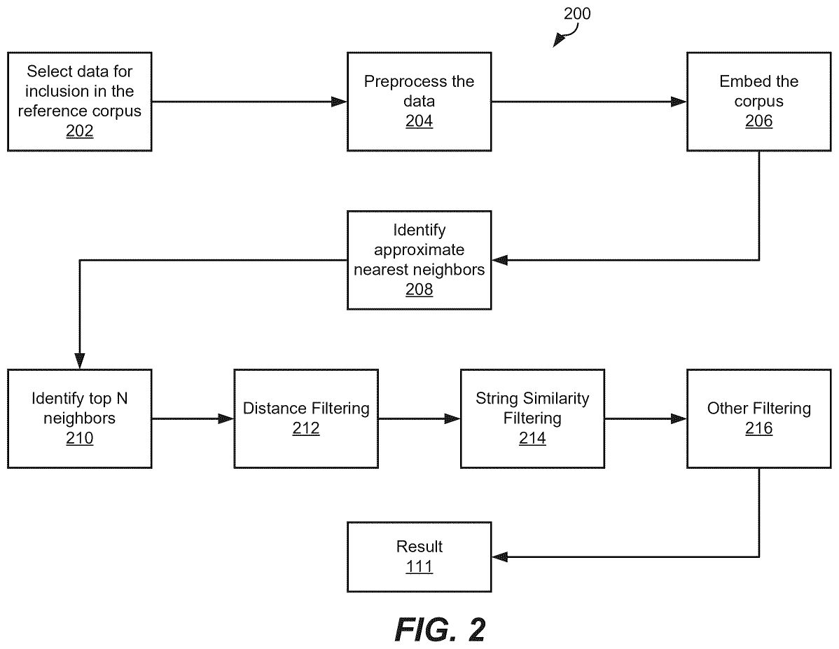

FIG. 2 illustrates an example of a data flow 200 for efficient search based on an approximate nearest neighbor model (such as the similarity model 126). Reference will be made to features described in FIG. 1 for illustration. At 202, the search system 120 may select data for inclusion in the reference corpus 105. The type of data for inclusion in the reference corpus 105 will vary depending on the context in which the data flow 200 is implemented.

At 204, the search system 120 may preprocess the selected data. Preprocessing may include removing or correcting errors in strings, removing certain characters such as whitespace or symbols, lower (or upper) casing all characters, and/or other data cleaning. In some examples, data may be curated depending on the context in which the search system 120 is implemented. For example, to label data for machine learning, the preprocessing may include selecting or filtering out certain data records 107.

At 206, the search system 120 may embed the reference corpus 105. For example, the vectorization subsystem 122 may vectorize the data records 107 in the reference corpus 105 and the indexing subsystem 124 may generate the indexed data structure 125 to embed the reference corpus 105.

At 208, the similarity model 126 may receive a query vector for searching the indexed data structure 125 and identify approximate nearest k neighbors, in which k is an integer defined by the k-value, which is a model-specific parameter 101.

At 210, the filter subsystem 128 may identify the top N-neighbors from among the nearest k neighbors, in which N is an integer defined by an N-value, which is a filter parameter 103.

At 212, the filter subsystem 128 may perform distance filtering. At 214, the filter subsystem 128 may perform string similarity filtering. At 216, the filter subsystem 128 may perform other types of filtering, such as filtering by a date field, a category type field, and/or other fields of a data record 107 corresponding to a top N and filtered k-nearest neighbor to generate the query result 111.

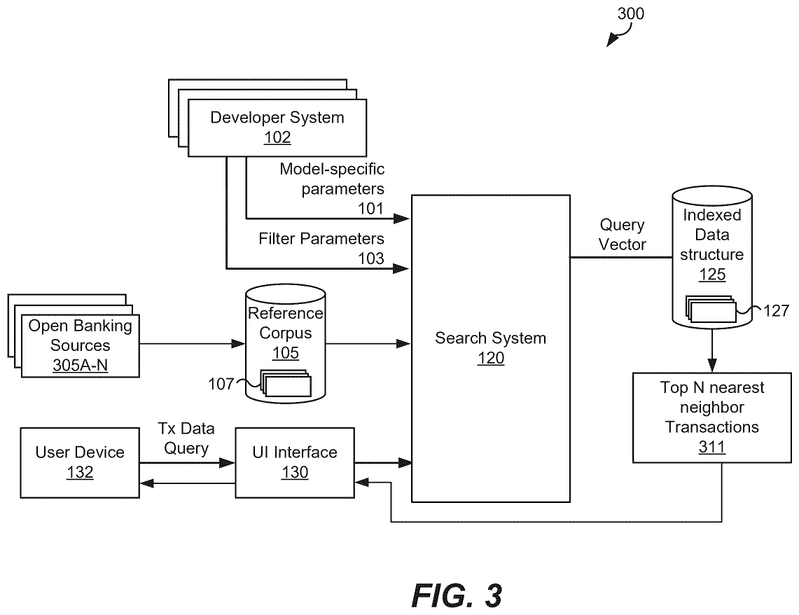

FIG. 3 illustrates an example of an implementation of an efficient approximate nearest neighbors search for searching open banking and other transaction data records. In this implementation, the reference corpus 105 may include open banking data from one or more open banking sources 305A-N. The indexed data structure 125 in this example will include reference vectors 127 corresponding to the open banking records. Open banking is a financial services concept in which data from banking services are shared with third-party developers, such as through Application Programming Interfaces (APIs). Customers may consent to allow access to this information, which allows third parties to access customer banking information and build applications or services around it. Searching open banking data can be challenging because of the volume of data and different ways in which banks and other banking sources 305 provide data. Furthermore, oftentimes, banking records include open text such as merchant names that are not indexed may be difficult to search.

To illustrate, a user may query open banking records to find transactions at a specific merchant. But the merchant name may not appear as expected. For example, a user may wish to find transactions related to “Abracadabra Inc.” The user may access a UI interface 130, which amy be provided by the user's bank or other services provider. The UI interface 130 may provide inputs to enter transaction query data for searching. The user may input the string “Abracadabra Inc.” to execute the search. The open banking records may store the merchant name “Abra Inc.” because of the way in which the merchant name is reported. A conventional search may be unable to find this record, but a vectorized approximate neighborhood search may result in the “Abra Inc.” record to be an approximate nearest neighbor to the query vector generated from “Abracadabra Inc.”

The UI interface 130 may directly, or via the search API 140 illustrated in FIG. 1, transmit the input string to the search system 120. The search system 120 may generate a query vector 117 corresponding to the input string and identify the top N approximate nearest neighbors 311 in the indexed data structure 125. The search system 120 may further filter the top N approximate nearest neighbors 311 based on distance, string similarity, and/or other filter parameter (such as other query inputs like transaction date, merchant type, and so forth, that the user provided via the UI interface 130). The search system 120 may return the top N approximate nearest neighbors 311, which may have been further filtered, back through the UI interface 130.

It should be noted that the example flow illustrated in FIG. 3 may be used for other purposes as well or instead. For example, the flow illustrated in FIG. 3 may be used to determine whether or not an input transaction is fraudulent by searching the input transaction against known fraudulent transactions. In this example, the reference corpus 105 may include data records 107 associated with known fraudulent transactions. The reference vectors 127 may, in this example, be vector representations of known fraudulent transactions such that if there exist top N approximate nearest neighbors to the input query, this suggests that the input query is associated with a fraudulent transaction. It should be further noted that the model-specific parameters 101 and/or the filter parameters 103 for these and other searches described herein may be configured as needed by developers or others to fine-tune outputs.

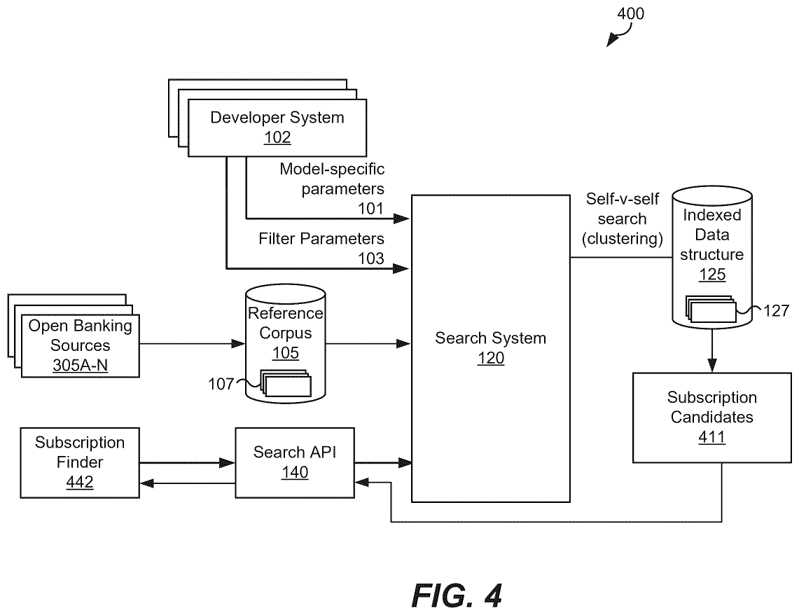

FIG. 4 illustrates an example of an implementation of an efficient approximate nearest neighbors search based on a self search of a reference corpus 105 that has been vectorized. In this implementation, the search system 120 may be used to identify recurring transactions in open banking and/or other transaction data. To do so, the search system 120 may conduct a self search of the indexed data structure 125. Ordinarily, the large number of records in open banking and other transaction data may make self searches to be potentially prohibitive. However, the search system 120 may be able to perform efficient self-searches.

A subscription finder 442 is a service that identifies recurring transactions in open banking and/or other transaction data by submitting a request to the search system 120. The request may include an identifier, such as a user or account identifier. The search system 120 may identify relevant data records 107 based on the identifier and generate a indexed data structure 125 from the identified data records 107. Alternatively, the indexed data structure 125 may already include relevant records that are each associated with the identifier or other account information. The search system 120 may cluster approximate nearest neighbors in the relevant records. Clustering may be graph-based, density-based, hierarchical, or point-based.

In graph-based clustering, the search system 120 may construct a k-Nearest Neighbor Graph. For example, the search system 120 may implement clustering techniques such as Louvain, Leiden, or Infomap to the graph structure of the indexed data structure 125 to identify clusters. In density-based clustering, the search system 120 may, for each point, find neighbors within a certain radius. The number of neighbors within this radius can be used as an estimate of the local density around that point. In point-based clustering, the search system 120 may select a random point in the vector space and select nearest neighbors around the random point to form a cluster. The search system 120 may repeat this process with another random point.

Clusters are each indicative of similar transactions in the indexed data structure 125. If transactions in a cluster occur over recurring periods, then the cluster represents a potentially recurring transaction and is flagged as a subscription candidate 411. The subscription candidates 411 may be reported back to the subscription finder 442, which may present the subscription candidate 411 to a user and/or automatically perform a mitigative action such as by terminating the subscription candidate 411.

It should be noted that a user or other may also use the search system 120 to identify whether a specific transaction is a recurring transaction. For example, if a user suspects that a given transaction is a recurring transaction, the user may input the suspected transaction for searching against the indexed data structure 125. Top N approximate nearest neighbors that are deemed to be similar to the suspected transaction may confirm that the suspected transaction is a recurring transaction.

Table 1 shows an example of a subscription candidate 411 based on a recurring transaction involving “Electric Co.” The search system 120 may cluster these transactions to identify their relatedness and determine that they occur over a recurring period (monthly at March, April, and May). This example provides only a small number of entries for illustration. Typically, the number of entries will be much larger, and more complex to search for and identify in a traditional all-v-all search.

Account statement

Electric Co utility bill March 2024
DeliverySvc INC chinese grill
Electric Co utility bill April 2024
P2P Inc Transfer to Ipsum
Electric Co utility bill May 2024
B2B payment transfer

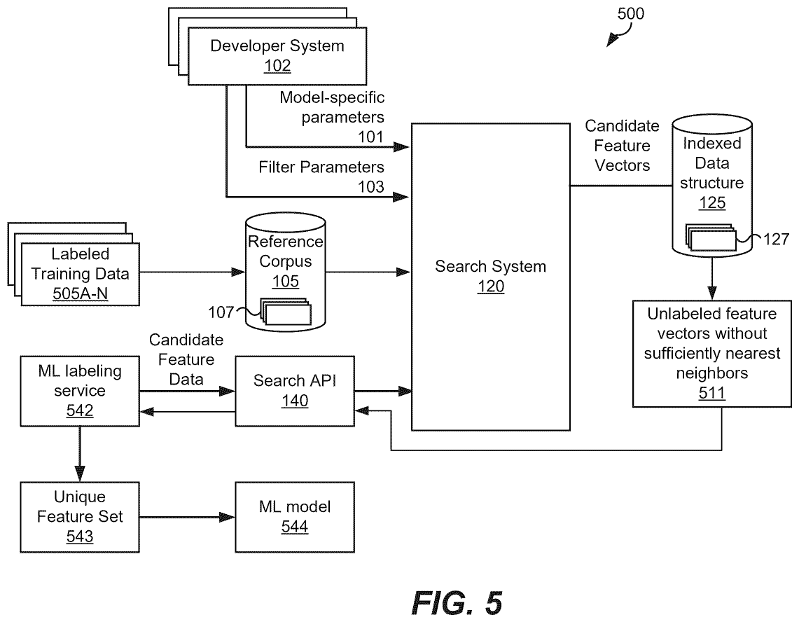

FIG. 5 illustrates an example of an implementation of an efficient approximate nearest neighbors search of an unlabeled data record against labeled data records that have been vectorized to identify unique candidate data for labeling and training ML models. In this implementation, the reference corpus 105 includes known feature data for training machine learning models 544. The indexed data structure 125 in this example will include reference vectors 127 corresponding to the known feature data. The input to the search system 120 may be candidate feature data that may be be added as a labeled (or unlabeled) feature if it is a new feature. Top N nearest neighbors to a vectorized query input that exceed filter criteria indicates that the candidate feature data is not new (is already present in the reference corpus 105). On the other hand, if there are no top N nearest neighbors to a vectorized query input that exceed filter criteria, this means that the candidate feature data is new (does not exist in the reference corpus 105). In this case, the ML labeling service 542 may add the candidate feature to a unique feature set 543 for training the training machine learning models 544.

Table 2 illustrates a particular labeling use case in which a labeled dataset, Dataset A and a large unlabeled dataset, Dataset B, includes a candidate feature. New candidate features are flagged for labeling. Labeling efficiency is improved, such as by at least 2-3x, by sending only unique transactions for labeling. This can greatly improve labeling systems that traditionally labels all data, whether already labelled or not.

| Dataset A | Dataset B | Labeling logic for Dataset B |
|---|---|---|
| ABC video ref id 5324vef | Acme grocery | Unique, send for labeling |
| Delivery Co chinese grill | Store purchase gas | Unique, send for labeling |
| Mart purchase | ABC video ref id 1234cdr | Found a similar transaction in |
| | | Dataset A, don't send for |
| | | labeling |
| P2P Transfer to Ipsum | P2P transfer to Lorem | Found a similar transaction in |
| | | Dataset A, don't send for labeling |
| . . . | . . . | . . . |
| B2B payment transfer | Spacy's credit adjustment | Unique, send for labeling |

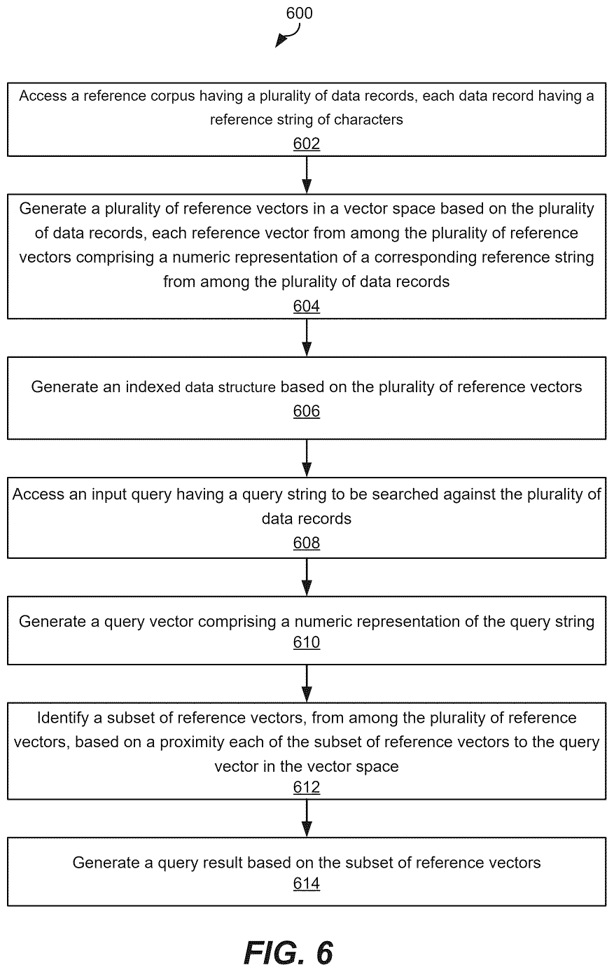

FIG. 6 illustrates an example of a method 600 of generating and efficiently searching an indexed vector data structure.

At 602, the method 600 may include accessing a reference corpus (such as reference corpus 105) having a plurality of data records (such as data records 107), each data record having a reference string of characters. At 604, the method 600 may include generating a plurality of reference vectors (such as reference vectors 127) in a vector space based on the plurality of data records, each reference vector from among the plurality of reference vectors comprising a numeric representation of a corresponding reference string from among the plurality of data records.

At 606, the method 600 may include generating an indexed data structure (such as the indexed data structure 125) based on the plurality of reference vectors. At 608, the method 600 may include accessing an input query (such as the input query 109) having a query string to be searched against the plurality of data records. The input query may originate from a user device (such as a user device 132) or a service (such as a service 142). At 610, the method 600 may include generating a query vector (such as the query vector 117) comprising a numeric representation of the query string.

At 612, the method 600 may include identifying a subset of reference vectors, from among the plurality of reference vectors, based on a proximity each of the subset of reference vectors to the query vector in the vector space. The subset of reference vectors may include the k-nearest neighbors in which k is an integer defined by a k-value model-specific parameter 101. At 614, the method 600 may include generating a query result (such as the query result 111) based on the subset of reference vectors.

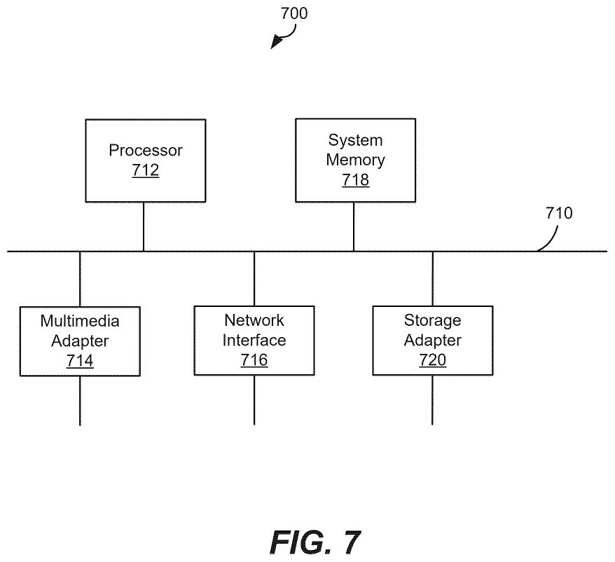

FIG. 7 illustrates an example of a computer system 700 that may be implemented by devices illustrated in FIG. 1. The computer system 700 may be part of or include the system environment 100 to perform the functions and features described herein. For example, various ones of the devices of system environment 100 may be implemented based on some or all of the computer system 700. The computer system 700 may include, among other things, an interconnect 710, a processor 712, a multimedia adapter 714, a network interface 716, a system memory 718, and a storage adapter 720.

The interconnect 710 may interconnect various subsystems, elements, and/or components of the computer system 700. As shown, the interconnect 710 may be an abstraction that may represent any one or more separate physical buses, point-to-point connections, or both, connected by appropriate bridges, adapters, or controllers. In some examples, the interconnect 710 may include a system bus, a peripheral component interconnect (PCI) bus or PCI-Express bus, a HyperTransport interconnect, an industry standard architecture (ISA)) bus, a small computer system interface (SCPI) bus, a universal serial bus (USB), IIC (I2C) bus, or an Institute of Electrical and Electronics Engineers (IEEE) standard 1384 bus, or “firewire,” or other similar interconnection element.

In some examples, the interconnect 710 may allow data communication between the processor 712 and system memory 718, which may include read-only memory (ROM) or flash memory (neither shown), and random-access memory (RAM) (not shown). It should be appreciated that the RAM may be the main memory into which an operating system and various application programs may be loaded. The ROM or flash memory may contain, among other code, the Basic Input-Output system (BIOS) which controls basic hardware operation such as the interaction with one or more peripheral components.

The processor 712 may control operations of the computer system 700. In some examples, the processor 712 may do so by executing instructions such as software or firmware stored in system memory 718 or other data via the storage adapter 720. In some examples, the processor 712 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

The multimedia adapter 714 may connect to various multimedia elements or peripherals. These may include devices associated with visual (e.g., video card or display), audio (e.g., sound card or speakers), and/or various input/output interfaces (e.g., mouse, keyboard, touchscreen).

The network interface 716 may provide the computer system 700 with an ability to communicate with a variety of remote devices over a network. The network interface 716 may include, for example, an Ethernet adapter, a Fibre Channel adapter, and/or other wired- or wireless-enabled adapter. The network interface 716 may provide a direct or indirect connection from one network element to another, and facilitate communication to and between various network elements. The storage adapter 720 may connect to a standard computer readable medium for storage and/or retrieval of information, such as a fixed disk drive (internal or external).

Other devices, components, elements, or subsystems (not illustrated) may be connected in a similar manner to the interconnect 710 or via a network. The devices and subsystems can be interconnected in different ways from that shown in FIG. 6. Instructions to implement various examples and implementations described herein may be stored in computer-readable storage media such as one or more of system memory 718 or other storage. Instructions to implement the present disclosure may also be received via one or more interfaces and stored in memory. The operating system provided on computer system 700 may be MS-DOS®, MS-WINDOWS®, OS/2®, OS X®, IOS®, ANDROID®, UNIX®, Linux®, or another operating system.

The term “based on” means based at least in part on. In the Figures, the use of the letter “N” to denote plurality in reference symbols is not intended to refer to a particular number. For example, “101A-N” does not refer to a particular number of instances of 101A-N, but rather “two or more.”

The databases (such as 105 and similar databases, which may store model features, parameters, hyperparameters, and/or other data related to training or executing the similarity model 126) may be, include, or interface to, for example, an Oracle™ relational database sold commercially by Oracle Corporation. Other databases, such as Informix™, DB2 or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The database may include cloud-based storage solutions. The database may store a plurality of types of data and/or files and associated data or file descriptions, administrative information, or any other data. The various databases may store predefined and/or customized data described herein.

The systems and processes are not limited to the specific embodiments described herein. In addition, components of each system and each process can be practiced independently and separate from other components and processes described herein. Each component and process may also be used in combination with other assembly packages and processes. The flow charts and descriptions thereof herein should not be understood to prescribe a fixed order of performing the method blocks described therein. Rather the method blocks may be performed in any order that is practicable including simultaneous performance of at least some method blocks. Furthermore, each of the methods may be performed by one or more of the system components illustrated in FIG. 1.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure has been described in terms of various specific embodiments, those skilled in the art will recognize that the disclosure can be practiced with modification within the spirit and scope of the claims.

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. Example computer-readable media may be, but are not limited to, a flash memory drive, digital versatile disc (DVD), compact disc (CD), fixed (hard) drive, diskette, optical disk, magnetic tape, semiconductor memory such as read-only memory (ROM), and/or any transmitting/receiving medium such as the Internet or other communication network or link. By way of example and not limitation, computer-readable media comprise computer-readable storage media and communication media. Computer-readable storage media are tangible and non-transitory and store information such as computer-readable instructions, data structures, program modules, and other data. Communication media, in contrast, typically embody computer-readable instructions, data structures, program modules, or other data in a transitory modulated signal such as a carrier wave or other transport mechanism and include any information delivery media. Combinations of any of the above are also included in the scope of computer-readable media. The article of manufacture containing the computer code may be made and/or used by executing the code directly from one medium, by copying the code from one medium to another medium, or by transmitting the code over a network.

This written description uses examples to disclose the embodiments, including the best mode, and to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system, comprising:
a processor programmed to:
access a reference corpus having a plurality of data records, each data record having a reference string of characters;
generate a plurality of reference vectors in a vector space based on the plurality of data records, each reference vector from among the plurality of reference vectors comprising a numeric representation of a corresponding reference string from among the plurality of data records;
generate an index based on the plurality of reference vectors;
access an input query having a query string to be searched against the plurality of data records;
generate a query vector comprising a numeric representation of the query string;
identify a subset of reference vectors, from among the plurality of reference vectors, based on a proximity each of the subset of reference vectors to the query vector in the vector space; and
generate a query result based on the subset of reference vectors.

2. The system of claim 1, wherein to generate the index, the processor is further programmed to:
partition the plurality of reference vectors recursively based on a portioning value until the plurality of reference vectors are indexed into a tree structure in which leaf nodes represent reference vectors, from among the plurality of reference vectors, that are similar to one another in each leaf node.

3. The system of claim 1, wherein to generate the index, the processor is further programmed to:
for each reference vector, from among the plurality of reference vectors, assign the reference vector into a respective hash bin, wherein reference vectors that are similar to one another according to a similarity metric in the vector space are hashed into the same hash bin.

4. The system of claim 1, wherein to generate the index, the processor is further programmed to:
for each reference vector, from among one or more reference vectors:
determine a nearest neighbor based on a similarity metric in the vector space;
generate an edge between the reference vector and the nearest neighbor; and
generate a graph structure based on the reference vector, the nearest neighbor, and the edge.

5. The system of claim 1, wherein to generate the query result, the processor is further programmed to:
filter the subset of reference vectors to reduce a number of the subset of reference vectors that are included in the query result.

6. The system of claim 5, wherein to filter the subset of reference vectors, the processor is further programmed to:
for each closest reference vector from among the subset of reference vectors:
compare a distance in the vector space between the closest reference vector and the query vector; and
filter the closest reference vector based on the distance.

7. The system of claim 5, wherein to filter the subset of reference vectors, the processor is further programmed to:
access the query string from which the query vector was generated;
for each closest reference vector from among the subset of reference vectors:
access a reference string for the closest reference vector;
determine a string similarity between the reference string and the query string; and
filter the subset of reference vectors based on the string similarity, wherein the query result is based on the filtered subset of reference vectors.

8. The system of claim 5, wherein to filter the subset of reference vectors, the processor is further programmed to:
access the query string from which the query vector was generated;
for each closest reference vector from among the subset of reference vectors:
compare a distance in the vector space between the closest reference vector and the query vector; and
filter the closest reference vector based on the distance.

9. The system of claim 1, wherein the plurality of data records correspond to transaction data and the input query corresponds to a transaction for which a match to the transaction data is queried.

10. The system of claim 1, wherein the plurality of data records correspond to labeled training data for a machine learning model, and the input query corresponds to a candidate feature data that is to be labeled if the input query is not similar to labeled data in the labeled training data.

11. A method, comprising:
accessing, by a processor, a reference corpus having a plurality of data records, each data record having a reference string of characters;
generating, by the processor, a plurality of reference vectors in a vector space based on the plurality of data records, each reference vector from among the plurality of reference vectors comprising a numeric representation of a corresponding reference string from among the plurality of data records;
generating, by the processor, an index based on the plurality of reference vectors;
accessing, by the processor, an input query having a query string to be searched against the plurality of data records;
generating, by the processor, a query vector comprising a numeric representation of the query string;
identifying, by the processor, a subset of reference vectors, from among the plurality of reference vectors, based on a proximity each of the subset of reference vectors to the query vector in the vector space; and
generating, by the processor, a query result based on the subset of reference vectors.

12. The method of claim 11, wherein generating the index comprises:
partitioning the plurality of reference vectors recursively based on a portioning value until the plurality of reference vectors are indexed into a tree structure in which leaf nodes represent reference vectors, from among the plurality of reference vectors, that are similar to one another in each leaf node.

13. The method of claim 11, wherein generating the index comprises:
for each reference vector, from among the plurality of reference vectors, assigning the reference vector into a respective hash bin, wherein reference vectors that are similar to one another according to a similarity metric in the vector space are hashed into the same hash bin.

14. The method of claim 11, wherein generating the index comprises:
for each reference vector, from among one or more reference vectors:
determining a nearest neighbor based on a similarity metric in the vector space;
generating an edge between the reference vector and the nearest neighbor; and
generating a graph structure based on the reference vector, the nearest neighbor, and the edge.

15. The method of claim 11, wherein generating the query result comprises:
filtering the subset of reference vectors to reduce a number of the subset of reference vectors that are included in the query result.

16. The method of claim 15, wherein filtering the subset of reference vectors comprises:
for each closest reference vector from among the subset of reference vectors:
comparing a distance in the vector space between the closest reference vector and the query vector; and
filtering the closest reference vector based on the distance.

17. The method of claim 15, wherein filtering the subset of reference vectors comprises:
accessing the query string from which the query vector was generated;
for each closest reference vector from among the subset of reference vectors:
accessing a reference string for the closest reference vector;
determining a string similarity between the reference string and the query string; and
filtering the subset of reference vectors based on the string similarity, wherein the query result is based on the filtered subset of reference vectors.

18. The method of claim 15, wherein filtering the subset of reference vectors comprises:
accessing the query string from which the query vector was generated;
for each closest reference vector from among the subset of reference vectors:
comparing a distance in the vector space between the closest reference vector and the query vector; and
filtering the closest reference vector based on the distance.

19. A non-transitory computer readable medium storing instructions that, when executed by a processor, programs the processor to:
access an input query having a query string to be searched against a plurality of data records;
generate a query vector comprising a numeric representation of the query string;
identify a subset of reference vectors, from among a plurality of reference vectors, based on a proximity each of the subset of reference vectors to the query vector in a vector space shared with the plurality of reference vectors; and
generate a query result based on the subset of reference vectors.

20. The non-transitory computer readable medium of claim 19, wherein the instructions further program the processor to:
access a reference corpus having a plurality of data records, each data record having a reference string of characters;
generate the plurality of reference vectors in a vector space based on the plurality of data records, each reference vector from among the plurality of reference vectors comprising a numeric representation of a corresponding reference string from among the plurality of data records; and
generate an index based on the plurality of reference vectors.
